(19) United States
(12) Patent Application Publication
(10) Pub. No.: US 2011/0168215 A1
(43) Pub. Date: Jul. 14, 2011

(54) DEVICE FOR CLEANING A ROLL OF A ROLLING MILL

(75) Inventor: Pierre Anglade, Saint-Etienne (FR)

(73) Assignee: SIEMENS VAI METALS TECHNOLOGIES SAS, Saint-Chamond (FR)

(21) Appl. No.: 13/001,215

(22) PCT Filed: Jun. 27, 2008
(86) PCT No.: PCT/FR08/00920

§ 371 Date: Dec. 23, 2010

(51) Int. Cl. B08B 3/00

(52) U.S. Cl. 134/198

(57) ABSTRACT

A device for cleaning a roll of a steel strip conversion plant is configured to move parallel to an axis of the roll. At least an even number N>0 of parallel spray nozzles are oriented perpendicular to the axis of the roll. A first number N/2 of the nozzles are fixed to a first arm of a supporting member and a second number N/2 of nozzles are fixed to a second arm of the supporting member. The supporting member is coupled to an actuator, and the actuator has a travel of at least 1/N of a length of the roll.

The invention relates to the cleaning of a roll by high-pressure jet, for example a back-up roll or a working roll of a rolling mill, in particular of a skin-pass rolling mill.

Skin-pass rolling of steel strip is a cold rolling process carried out by traction with moderate elongation. A rolling mill which is capable of carrying out skin-pass operations is incorporated in many steel strip conversion lines, where it is principally used for the following purposes:
eliminating a resilient steel bearing and thus permitting improved quality of the pressed parts which will be ultimately produced in the strips,
improving the flatness of the strip,
imprinting a specific surface state onto the strip in order to improve the tribology of the pressing process.

In some instances, the surface of the rolls in skin-pass rolling mills may be contaminated by adhesions which impair the quality of the surface of the strip. This is the case, for example, in rolling mills installed in-line in continuous galvanizing plants. Particles of zinc adhere to the working roll. With each rotation of the roll, said particles are imprinted onto a surface of the strip and may alter its surface quality. A further example is in certain applications where it is necessary to provide lubrication of an air-gap of the working roll with an emulsion of water and lubricant. In this case, generally a deposit of grease is formed on the roll in the areas which are not in contact with the strip. If the width of the strip is changed, this deposit may prove detrimental by transferring roughness to the edges of the strip.

To resolve these problems, several solutions have been proposed. One solution uses devices for cleaning rolls by pressure spraying with detergent liquids. These operations were initially manual and then mechanized, as disclosed in JP 9 222 907. However, these devices which use low-pressure spray nozzles with a wide jet, prove effective for degreasing coatings of a lubricant product, due to the detergent action of a sprayed liquid, but they are not capable of eliminating adhesions, in particular of zinc particles.

A further solution, disclosed in EP 0 995 504, uses high-powered spray nozzles with a narrow jet, which causes two problems:
the need to adjust accurately the distance between the nozzle and the roll to be cleaned, i.e. to be adapted to the diameters of the different rolls used,
the need for the impact of the jets to cover the entire length of the roll, resulting in an excessive increase in the number of spray nozzles.

This arrangement requires a perfect adaptation of the speed of displacement of the lance to a speed of rotation of the roll according to the width of the impact of the jet. The patent discloses the possibility of adjusting the nozzle/roll distance and the speed of displacement of the nozzle. This method is limited by a low speed of displacement, due to the nature of high-pressure nozzles. Given the relatively small size of impact of a jet, it is necessary for the speed of displacement to be slow in order to guarantee good coverage of the impact. For rolls having a diameter in the region of 500 millimeters, a table length in the region of 2 meters and a peripheral speed of the strip in the region of 120 m/min to 650 m/min, the time for a nozzle to travel along the roll is approximately 1 minute 30 seconds. Based on continuously spraying back and forth, the end of the roll opposing the half-turning point of the nozzle is cleaned every 3 minutes and the end of the roll at the half-turning point is cleaned almost immediately, which constitutes a waste of cleaning liquid and unnecessarily increases wastage.

The object of the present invention is to resolve problems with the stability of the devices for cleaning and problems with the accuracy of the cleaning relative to a surface of the roll to be cleaned, the problems being caused by the lengthy travel of the displacement elements which result in a significant change in the center of gravity of the whole device and similarly high forces which act at the ends of the device, thus producing increased wear of the material.

A further object of the present invention is to reduce the length of time for cleaning the roll with each forward and return movement in a fixed period which is adjustable between 30 seconds and 1 minute. As the spraying is limited either to a single forward movement or single return movement, the wastage of cleaning liquid is eliminated.

The invention thus proposes a device for cleaning a roll of a steel strip conversion plant, which device is designed to move parallel to an axis of said roll, comprising:
at least an even number N>0 of parallel spray nozzles, said nozzles being perpendicular to the axis of the roll, a first number N/2 of the nozzles being fixed to a first arm of a supporting member and a second number N/2 of nozzles being fixed to a second arm of the supporting member, said supporting member being coupled to a displacement member, for example an actuator, the actuator having a travel of at least 1/N of the length of the roll.

These features are, in particular, reproduced in claim 1.

As the travel of the actuator is able to be considerably reduced (in comparison with systems comprising one nozzle) the arm(s) for bearing the nozzles are advantageously deployed with greater mechanical stability, permitting, for example, the nozzles to remain at a very uniform distance from the roll, whatever their deployment.

In these conditions, one of the areas of the roll swept by at least one nozzle is no longer cleaned in a time period which varies, for example, between 0 to 3 minutes with each forward-return movement but according to a fixed time period which is adjustable between 30 seconds and 1 minute according to the number N of nozzles selected. The cleaning frequency is thus capable of being increased for the purpose of improving the quality of cleaning as it is more intensive.

The subject of the invention and its advantages will be more clearly understood with reference to the sub-claims and the exemplary embodiments provided by the following figure:

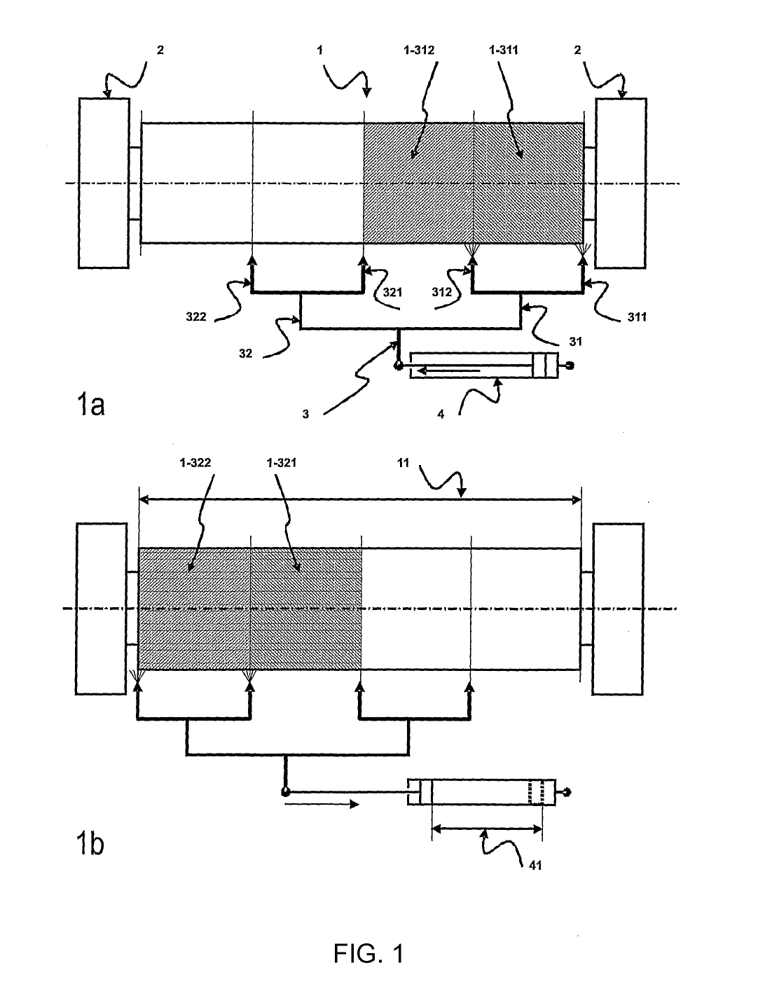

FIG. 1 an embodiment of a device for cleaning comprising four nozzles.

The figure is divided into two parts 1a and 1b. The two parts show a roll of a rolling mill (1) supported by bearings (2). A device for cleaning (3) is capable of being displaced opposite the roll (1) parallel to an axis (5) of the roll (1) by the action of an actuator (4). The device for cleaning (3) comprises two supporting members (31) and (32) each providing a supply of cleaning liquid from four nozzles (311, 312) and (321, 322) arranged in a first and in a second pair of nozzles on each of the two supporting members (31, 32).

During an advancing phase of the actuator (4), shown in part 1a of the figure, the two first nozzles (311, 312) are active and respectively clean a first area (1-311) and a second area (1-312) of the roll, said two areas being juxtaposed. The second pair of nozzles (321, 322) is thus inactive.

During the return phase of the actuator (4), shown in part 1b of the figure, the second pair of nozzles (321, 322) becomes active and respectively cleans a third area (1-321) and a fourth area (1-322) of the roll, said two areas being juxtaposed and offset relative to the preceding areas. The first pair of nozzles (311, 312) is thus inactive.

The travel (41) of the actuator (4) is at least equal to a quarter of a length (11) of the roll.

As already mentioned above, one major advantage of the invention is the fact that the displacement travel of the nozzles is reduced to 1/N of the length of the active surface of the rolls, which makes it possible to reduce the travel of the actuator (4) proportionately. This makes it possible to improve the stability of the device for cleaning (3) by minimizing a displacement of the center of gravity of the device, the displacement being caused with each travel of the actuator (4), in addition to increasing in the cleaning accuracy. In a variant of the device, the nozzles N are four in number. The advantage in the field of metalworking is to simplify the device (for example, to avoid an excessive number of nozzles) and also to reduce considerably the duration of a complete forward and return movement of the nozzles (311, 312, 321, 322). Advantageously, the N nozzles (311, 312, 321, 322) are capable of spraying a liquid at high pressure onto a surface of the roll (1). One use of the high-pressure nozzles makes it possible to improve the cleaning, using a reduced quantity of cleaning liquid. A further advantage is the fact that a high-pressure jet also makes it possible to benefit from mechanically removing the particles present on the surface of the roll, separately from chemical removal as a result of a detergent, which makes it possible to reduce the percentage of detergent present in the cleaning liquid.

The N nozzles (311, 312, 321, 322) are arranged at an equal distance from one another, said distance being equal to a portion 1/N (inversely proportional to the number N of nozzles) of the length of the roll (1). The distance between the nozzles is equal, making it possible to define for each of the N nozzles a precise part to be cleaned of the surface of the roll, avoiding cleaning areas which are superposed, and thus superfluous.

In a further variant, the device comprises means for adjusting a distance between the N nozzles and the roll. Advantageously, this variant makes it possible to adjust the width of the jet sprayed by the nozzles, in other words, to adjust the contact surface of the jet with the roll. For example, in cases where cleaning at particular points is required, the distance is reduced.

The actuator (4) is arranged so that its travel (which is minimized due to the number of nozzles distributed on the supporting members/arms adjoining the actuator) is parallel to the axis of the roll (1). As the invention provides that the travel is minimized due to the number of nozzles distributed over the supporting members/arms adjoining the actuator, the parallel nature of said travel is all the more easy to ensure without having recourse to a heavy, bulky, complex and costly actuator positioning system.

The device comprises a control means capable of activating a first portion of N nozzles (311, 312, 321, 322) and at the same time deactivating a second portion of N nozzles which are stationary during a first movement of the N nozzles caused by an advance of the actuator (4), said control means also being capable of deactivating the first portion and activating the second portion during a second movement of the N nozzles (311, 312, 321, 322) caused by a retraction of the actuator (4).

The resulting advantage is, therefore, that a waste of cleaning liquid is reduced and that the time for the forward and return movement of the nozzles is reduced.

### ABBREVIATIONS

1=roll

2=bearings

3=device for cleaning

4=actuator

5=axis of the roll

11=length of the roll

31=first arm

32=second arm

41=travel of the actuator

311=first nozzle

312=second nozzle

321=third nozzle

322=fourth nozzle

1-311=first area

1-312=second area

1-321=third area

1-322=fourth area

1-5. (canceled)

6. A device for cleaning a roll of a steel strip conversion plant, the roll having an axis and a given length, the device comprising:
at least an even number N>0 of parallel spray nozzles, said nozzles being oriented perpendicular to the axis of the roll;
a supporting member having a first arm carrying a first number N/2 of said spray nozzles and a second arm carrying a second number N/2 of said spray nozzles; and
an actuator coupled to said supporting member for moving said supporting member with said spray nozzles parallel to the axis of the roll, said actuator having a displacement travel of at least 1/N of the length of the roll.

7. The device according to claim 6, wherein the number of nozzles N=4.

8. The device according to claim 6, wherein said N nozzles are disposed equidistant from one another, and a distance between said nozzles is equal to a portion 1/N of the length of the roll.

9. The device according to claim 6, comprising a device for adjusting a distance between said spray nozzles and the roll.

10. The device according to claim 6, which further comprises a control device configured to activate a first portion of said N nozzles and at the same time deactivating a second portion of said N nozzles which are stationary during a first movement of the N nozzles caused by an advance of said actuator, said control device further being configured to deactivate the first portion and activate the second portion during a second movement of said N nozzles caused by a retraction of said actuator.
